(19) United States
(12) Patent Application Publication
(10) Pub. No.: US 2019/0366722 A1
(43) Pub. Date: Dec. 5, 2019

(54) Printable Graphene Oxide Coatings and Membranes

(71) Applicant: UNIVERSITY OF SOUTH CAROLINA, COLUMBIA, SC (US)

(72) Inventors: MIAO YU, PITTSFORD, NY (US); MAHDI FATHIZADEH, COLUMBIA, SC (US)

(21) Appl. No.: 16/477,252

(22) PCT Filed: Jan. 24, 2018
(86) PCT No.: PCT/US18/14937

§ 371 Date: Jul. 11, 2019

Related U.S. Application Data
(60) Provisional application No. 62/450,308, filed on Jan. 25, 2017.

(51) Int. Cl. B41J 2/17; C09D 11/324; B41M 1/30; B41J 2/045; B41J 2/32

(52) U.S. Cl. CPC B41J 2/17; C09D 11/324; C01B 32/198; B41J 2/04581; B41J 2/32; B41M 1/30

(57) ABSTRACT

The present disclosure relates to methods of printing graphene oxide (GO) and printed GO membranes. An embodiment of the present disclosure includes producing graphene oxide (GO) ink by mixing graphene oxide particles with a solvent. The GO ink can be inserted into a printer and the printer head can expel droplets of GO ink on the substrate. The GO ink can be dried on the substrate and the substrate can then be used for various applications including a medium for filtering water.

### CROSS-REFERENCE TO A RELATED APPLICATION

The present application claims priority to U.S. Provisional Patent Application Ser. No. 62/450,308 titled “Fast and Scalable Production of Ultrathin GO-Based Membranes/Coatings by Printing” of Miao Yu, et al. filed on Jan. 25, 2017, the disclosure of which is incorporated by reference herein.

### GOVERNMENT SUPPORT

The subject invention was made with government support under a research project supported by the National Science Foundation (NSF) Grant Number 1451887. The government has certain rights in the invention.

### FIELD OF THE INVENTION

The present disclosure relates to graphene-oxide membranes. More specifically, the present disclosure relates to graphene-oxide membranes produced using printing techniques.

### BACKGROUND

Graphene oxide (GO), a two-dimensional (2D) carbon-based material, has attracted attention for its use in water filtration membranes. Various solution-based deposition methods of fabricating graphene oxide membranes have been introduced, including vacuum filtration, drop-casting, and spin coating. However, several challenges still remain in the fabrication of graphene oxide membranes, including the ability to effectively scale production. Further, graphene oxide membranes have also shown inconsistent filtration performance, low water permeance, and uneven graphene oxide application. The present disclosure seeks to improve on these deficiencies of the prior art as well as others.

### BRIEF SUMMARY

Aspects and advantages of embodiments of the present disclosure will be set forth in part in the following description, or may be learned from the description, or may be learned through practice of the embodiments.

An embodiment of the present disclosure includes a method of fabricating graphene oxide membranes using a printing process. Graphene oxide (GO) ink can be produced by mixing graphene oxide particles with a solvent. The GO ink can be inserted into a printer and the printer head can expel droplets of GO ink on a substrate. The GO ink can be dried on the substrate and the substrate can then be used for various applications, including a medium for filtering water. For instance, the resulting substrate can be used to remove organic contaminants, such as endocrine disrupting compounds, pharmaceuticals, personal care products, and salts in water to produce drinking water.

These and other features, aspects, and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

FIG. 1 illustrates a method for depositing water-based graphene oxide (GO) ink on hydrophilic and hydrophobic support substrates according to an embodiment of the present disclosure.

FIG. 2 illustrates the orifices of an inkjet print head utilized in an embodiment of the present disclosure.

FIG. 3 illustrates a graphene oxide (GO) layer filtering contaminants from water.

FIG. 4(a) illustrates a method of printing graphene oxide membranes according to an embodiment of the present disclosure.

FIG. 4(b) is an image of a printed GO membrane according to an embodiment of the present disclosure.

FIG. 4(c) illustrates a Field Emission Scanning Electron Microscopy (FESEM) image of the surface of a printed GO membrane according to an embodiment of the present disclosure.

FIG. 4(d) illustrates an FESEM cross-sectional image of the surface of a printed GO membrane according to an embodiment of the present disclosure.

FIG. 4(e) is a graph showing the average printed GO coating thickness measured as by FESEM as a function of GO concentration for a single-pass printing method according to an embodiment of the present disclosure.

FIG. 4(f) is a graph of the water contact angle as a function of average printed GO layer thickness.

FIG. 5(a) is a graph illustrating pure water permeance (PWP) based on printed graphene oxide thickness.

FIG. 5(b) is a graph showing membrane pressure drop versus pure water flux.

FIG. 6 shows the nanofiltration performance of printed GO membranes (a double-pass printed, 30 nm GO membrane) and a commercial membrane removing iodixanol (10 ppm) using a cross-flow system over an extended operating period (J₀=DI water permeability; J=iodixanol permeability; ▪: 30 nm, double-pass printed membrane; Δ: Microdyn Nadir commercial membrane).

FIG. 7 is a graph illustrating GO ink viscosity as a function of GO concentration.

FIG. 8 is a graph illustrating the root mean square (rms) surface roughness (in nanometers) for various thicknesses of GO layers (“S” represents single-pass printing; “D” represents double-pass printing; and “Q” represents quadruple-pass printing).

### DETAILED DESCRIPTION

Aspects and advantages of embodiments of the present disclosure will be set forth in part in the following description, or may be learned from the description, or may be learned through practice of the embodiments.

Embodiments of the present disclosure include methods of applying graphene oxide to a substrate. The substrate can be a membrane such as a porous polymeric film, a fabric, or a porous ceramic. The graphene oxide can be applied using a printing process in which small droplets of graphene oxide (GO) ink are expelled from an orifice and onto the substrate. The substrate can then be dried and a high-quality layer of graphene oxide can be produced on the substrate. The thickness of the graphene oxide layer and its two-dimensional distribution on the substrate can be precisely controlled.

Methods of the present disclosure can produce fast, facile, and scalable coatings of graphene oxide (GO) on various substrates. GO layers can be produced with excellent lamellar structure and sub-nanometer nanochannels, which significantly enhance separation performance of GO membranes and the hydrophilicity of substrates printed with the GO. Using commercial printers and optimized GO ink, ultrathin and highly permeable GO membranes can be fabricated with low production cost and negligible GO loss during fabrication. Commercial printers and printing heads can be adapted to industrial scale for producing membranes suitable for high volume filtration of liquids and gasses.

Specific applications of the printed GO membranes of the present disclosure include water purification and the removal of organic contaminants such as endocrine disrupting compounds (EDCs) and other pharmaceuticals. Another example of applications of the printed GO membranes includes desalination to produce drinking water. The printed GO membranes may also be used for organic dehydration by pervaporation as well as for gas separation (e.g., CO₂/N₂ gas separation). The printed hydrophilic GO coatings can be applied on various porous substrates and fabrics to improve wetting of aqueous solutions on the substrates and fabrics

Experimentation with the printed GO membranes has shown high separation performance for desalination, removal of dye, and removal small organic contaminants in water. Advantages of the printed GO membranes include high water flux, low pressure operation, and low production costs. The printed GO membranes can also have increased fouling resistance and operation life relative conventional polymeric membranes.

A method of forming a graphene oxide (GO) layer according to the present disclosure can include producing GO ink and using an inkjet printer to apply the GO ink to a substrate. The GO ink can be produced by mixing GO nanoparticles with a solvent. The solvent can include water and/or organic solvents. Water is generally preferable for hydrophilic substrates and organic solvents are generally preferred for hydrophobic substrates. Examples of organic solvents include acetone and alcohols.

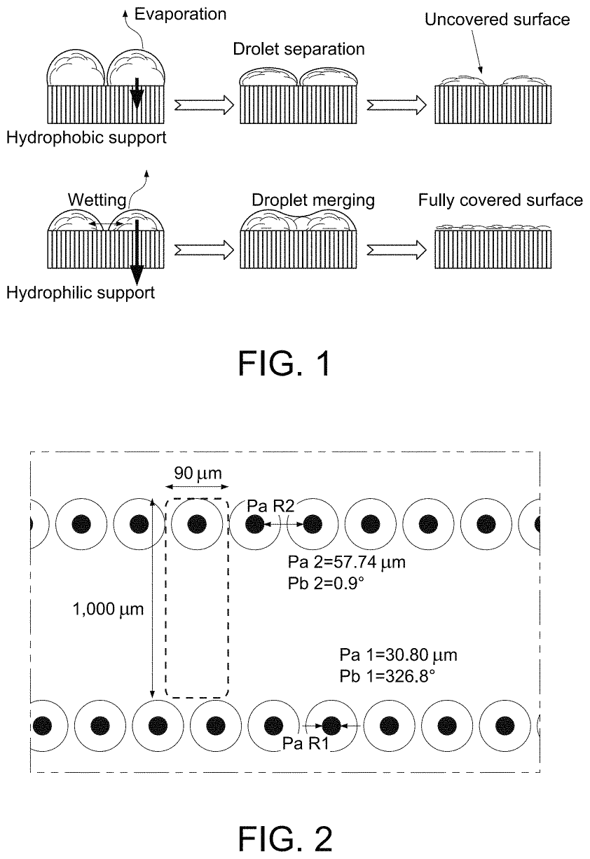

FIG. 1 illustrates a method for depositing water-based graphene oxide (GO) ink on a substrate according to the present disclosure. The top of FIG. 1 shows depositing water-based GO ink on a hydrophobic support substrate. The top of FIG. 1 shows the tendency of the water-based GO ink droplets to form discrete beads on the hydrophobic support substrate, which creates areas of the support membrane which remain uncovered. This also creates gaps in the GO layer as the solvent evaporates from the GO ink. This phenomenon of applying water-based GO ink to a hydrophobic substrate may be strategically employed when a patterned GO layer is desired.

The bottom of FIG. 1 shows applying water-based GO ink droplets to a hydrophilic support. The decreased surface tension between the GO ink and the substrate allows for greater wetting. If the GO ink droplets are large enough and/or the GO ink droplets are placed close enough together, the GO ink can fully cover the surface of the substrate. The GO ink can then be dried on the substrate to produce a high-quality GO layer having an even thickness. In contrast, when an organic-based solvent is used, the GO-ink will have a tendency to form discrete beads on hydrophilic substrates and spread on hydrophobic substrates.

Solvent mixtures can also be used in forming the GO ink, including mixtures of water and ethanol. Adding an alcohol or other organic solvent to water can help increase the rate at which the GO ink dries on the substrate. For example, the solvent can include a mixture of water and from about 5 wt. % to about 60 wt. % ethanol, such as from about 20 wt. % to about 50 wt. % ethanol, and from about 30 wt. % to about 45 wt. % ethanol. The pH and other characteristics of the GO ink can be adjusted using various additives. For example, acids or bases can be used to alter the molecular nature of the GO particles and/or improve the properties of the GO ink as it interfaces with the substrate. Surfactants and other modifiers can also be included in the GO ink to keep the GO particles suspended in the GO ink, reduce GO particle agglomeration, and otherwise improve GO-ink printing performance.

The GO ink can be formed by mixing the GO nanoparticles, the solvent, and potentially other additives. The mixing can be accomplished using a stirrer (e.g., a magnetic or paddle stirrer); however, sonication has been found to be particularly effective. Large GO particles and/or agglomerates in the GO ink can be removed by passing the GO ink through a membrane or by centrifuging the GO ink. The GO particle size can be adjusted based on the nozzle size to avoid clogging.

The GO ink can include GO particles that are a single atomic layer in thickness and have an average diameter of less than about 1000 nm, such as less than about 500 nm. For example, the GO particles can have an average diameter of from about 100 nm to about 2000 nm, such as from about 300 nm to about 1200 nm, and from about 400 nm to about 800 nm. Graphene oxide quantum dots can also be applied (e.g., having an average size ranging from about 2 nm to 10 nm) alone or in combination with larger GO particles. Controlling the size of the GO particles in the GO ink can be critical to the printing process. For example, having GO particles that are too large in size can plug printing head orifices and can also result in a poor distribution of the GO flakes on the substrate. In contrast, having GO particles that are too small in size can also result in negative impacts such as poor spacing between GO particles and poor GO membrane performance.

The concentration of GO particles is also an important aspect of the GO ink. Having too high of a GO concentration can result in GO particle agglomeration, plugging of the printing orifices, and poor distribution of GO particles on the substrate. Having too low of a GO particle concentration in the GO ink can cause GO layer fabrication inefficiencies, as well as other problems. It has been discovered that effective GO particles concentrations can range from about 0.1 mg/mL to about 10.0 mg/mL, such as from about 0.2 mg/mL to about 6.0 mg/mL, about 0.5 mg/mL to about 4.0 mg/mL, and about 1.0 mg/mL to about 3.0 mg/ML, based on the total volume of GO ink. The viscosity of the GO ink can also be an important factor in the GO printing methods of the present invention. Suitable GO ink viscosities can range from 0.5×10⁻⁴ PaS⁻¹ to 2.5×10⁻⁴ PaS⁻¹, such as from 0.8×10⁻⁴ PaS⁻¹ to 2.0×10⁻⁴ PaS⁻¹; 1.0×10⁻⁴ PaS⁻¹ to 1.7×10⁻⁴ PaS⁻¹; 1.1×10⁻⁴ PaS⁻¹ to 1.6×10⁻⁴ PaS⁻¹; and 1.15×10⁻⁴ PaS⁻¹ to 1.4×10⁻⁴ PaS⁻¹.

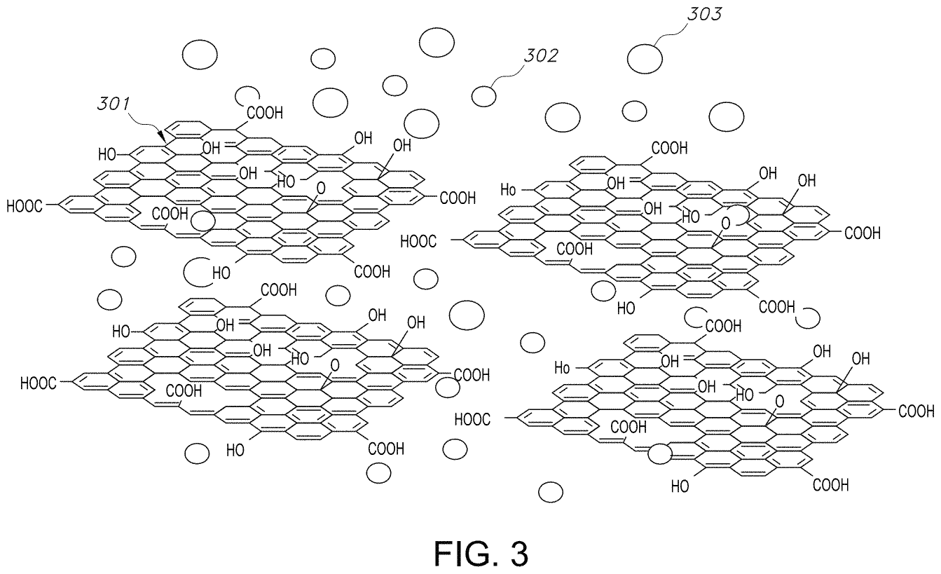

The GO ink can be applied to a substrate by expelling droplets through an orifice of a printer. An array of orifices arranged in two dimensions can also be used similar to that of commercial printers. FIG. 2 illustrates the orifices (i.e., nozzles, holes, pores) of an inkjet print head according to an embodiment of the present disclosure. FIG. 2 shows an array of orifices that are arranged in lines that run widthwise with lengthwise spacing between the lines of orifices. The size of the orifices is important and should be determined based on factors including the size of the GO particles in the GO ink and GO ink viscosity. For example, the inkjet orifice size can range from about 5 μm to about 100 μm, such as from about 15 μm to about 60 μm, about 20 μm to about 40 μm, and about 25 μm to about 35 μm.

The volume of the GO ink droplets ejected from the inkjet orifices can depend on the GO ink and the size of the inkjet orifices. For example, the volume of each drop of GO ink applied to the substrate can range from about 1×10⁻¹² L/drop to about 200×10⁻¹² L/drop, about 5×10⁻¹² L/drop to about 100×10⁻¹² L/drop, about 10×10⁻¹² L/drop to about 60×10⁻¹² L/drop, and about 15×10⁻¹² L/drop to about 30×10⁻¹² L/drop. The diameter of each droplet can range from about 1 μm to about 200 μm, such as from about 5 μm to about 120 μm, about 10 μm to about 75 μm, and about 20 μm to about 50 μm.

The GO ink droplets can be expelled from the inkjet orifices using a thermal or mechanical driving force. The thermal driving force can come from heating solvent in the printer head which causes vapor expansion and propels the GO droplet out of the inkjet orifice and onto the substrate. Alternatively, a physical driving force can also be used, such as a pump with a series of valves that open, or a piezoelectric crystal that expands behind the inkjet orifice and expels the GO ink onto the substrate.

Further, the density of GO ink droplets can be controlled. The number of GO ink droplets formed in a single line may be referred to as the number of dots per inch (dpi). For example, the GO ink droplets can be applied in a density of from about 100 dpi to about 3000 dpi, such as from about 200 dpi to about 2500 dpi, about 300 dpi to about 2000 dpi, about 500 dpi to about 1500 dpi, and about 800 dpi to about 1300 dpi.

The GO ink can be applied to form a GO layer on various types of substrates. Porous membranes substrates are particularly suitable for producing graphene oxide membranes. Examples of polymer substrates include porous polymer films and fabrics. Specific examples of polymer films include polyacrylonitrile (PAN) and poly-sulfone films.

The membranes can be porous membranes with skin-layer pore sizes ranging from about 5 nm to about 100 nm, such as from about 10 nm to about 75 nm, and from about 30 nm to about 50 nm. Prior to applying the GO droplets, the substrate can first be treated with a base, such as sodium hydroxide, or another substance to alter the surface chemistry of the substrate and improve the substrate's hydrophilicity or hydrophobicity. For example, a PAN support can be hydrolyzed with a sodium hydroxide solution to generate a super hydrophilic surface. Further, the acrylonitrile (—CN) group of PAN can be changed to an acid group, which is more hydrophilic than acrylonitrile.

After the GO ink is applied to the substrate, the GO ink can be allowed to dry naturally or under heat. The GO ink can be applied to the substrate such that the resultant GO layer is from about 2 layers to about 100 layers of GO sheets, such as from about 3 layers to about 50 layers of GO sheets, about 4 layers to about 40 layers of GO sheets, and about 5 to about 25 layers of GO sheets. The thickness of the GO layer can also be controlled to be from about 2 nm to about 100 nm, such as from about 5 nm to about 80 nm, about 10 nm to about 60 nm, and about 15 nm to about 40 nm. The average size of the nanochannels can also be controlled to be from about 5 Å to about 15 Å, such as from about 7 Å to about 11 Å.

The root means square surface (rms) roughness of the printed GO layer can also be controlled. For example, the average rms surface roughness of the GO layer can range from about 2 nm to about 100 nm, such as from about 10 nm to about 60 nm, about 15 nm to about 40 nm, about 18 nm to about 35 nm, and about 20 nm to about 30 nm. The water contact angle of the printed GO layer is also controllable using methods of the present disclosure. For example, the water contact angle can be from about 30° to about 60°, such as from about 33° to about 55°, about 35° to about 50°, about 38° to about 48°, and about 40° to about 45°.

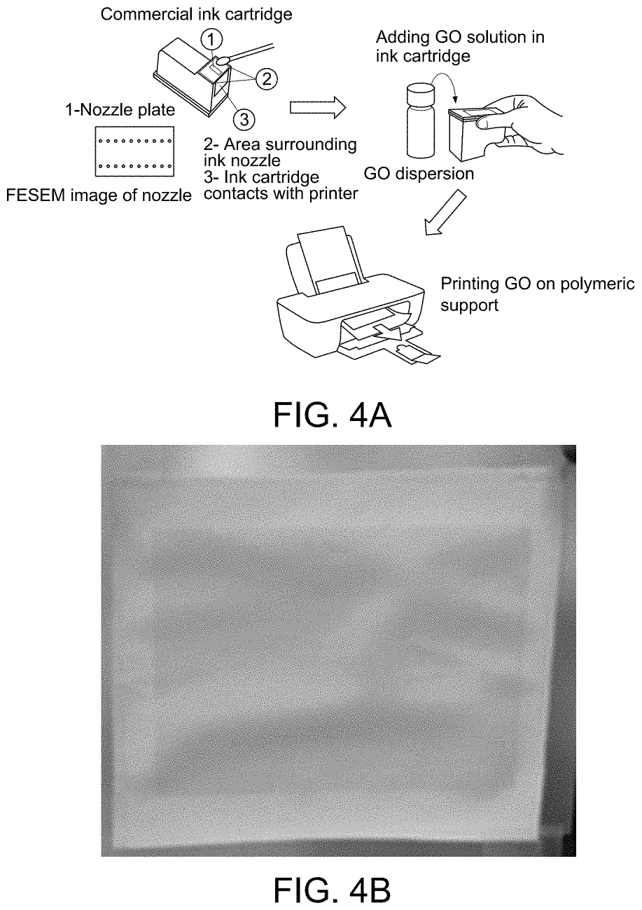

FIG. 3 illustrates a graphene oxide (GO) layer filtering contaminants 303 from water 302. Four individual GO flakes 301 are shown with nanochannels represented by the spaces between each of the GO flakes 301. The GO flakes 301 are a single atomic layer in thickness and have various functional groups including carboxylic acid and alcohol groups, which help increase the ability of GO to function as a filtration medium. Specifically, the oxygen-containing functional groups can allow small polar molecules, such as water, to easily permeate through the hydrophilic channels. Water 302 is shown making its way through the nanochannels while contaminants 303 are impeded by the GO layer.

### Example 1

Single-layer graphene oxide (SLGO) powder (500-700 nm) was purchased from Cheap Tubes, Inc. All the chemicals, including pharmaceutical components (gemfibrozil, 17α-ethynylestradiol, diclofenac sodium salt, and iodixanol), salts (sodium chloride (NaCl), magnesium chloride (MgCl₂), magnesium sulfate (MgSO₄), and sodium sulfate (Na₂SO₄) with purity higher than 99%), concentrated sulfuric acid (H₂SO₄, 99.99%), potassium permanganate (KMnO₄, >99%), hydrochloric acid (HCl, 37%), and hydrogen peroxide (H₂O₂, 30% (w/w)) were purchased from Aldrich and used without further purification. Expandable graphite (Grade 1721) was supplied by Asbury Carbon, and was used for synthesis of large GO flakes (>1 μm). The PAN (M-PA400-GPET) ultrafiltration membrane, with a pore size of 20-50 nm, was purchased from Nanostone Water, Inc. P030 (Microdyn Nadir), TS40 (Trisep®), and NF90 (Dow® Filmtec™) nanofiltration membranes were purchased from Sterlitech Corporation.

To prepare a modified polyacrylonitrile (M-PAN) support, the PAN support was first immersed in 2 M NaOH solution at 50° C. for 30 min. Then, M-PAN was washed with DI water several times and stored in DI water for 24 hours. The M-PAN was dried at room temperature for 12 hours before being used as a substrate for GO printing.

Graphene oxide (GO) ink was prepared by dispersing 400 mg of SLGO in 100 mL DI water by ultrasonication for 2 hours or more to ensure excellent dispersion of GO flakes in water. Then, the GO dispersion was centrifuged (5 minutes at 1,000 rpm) to remove any large particles or aggregates. No obvious GO concentration change, as confirmed by UV-vis measurements, was observed before and after centrifugation, indicating a negligible amount of GO aggregates. The supernatant was then collected and diluted in DI water to prepare different concentrations of GO ink. After making uniform GO ink, a commercial Deskj et 1112 HP® printer was used to print GO coatings on the surface of an M-PAN support. For single-pass printing, the printed GO membrane was dried for 12 hours at room temperature and then 2 hours at 80° C. For multi-pass printing, 4 hours of drying at room temperature was used between printings.

Surface morphology and thickness of the printed GO coatings were examined by Field Emission Scanning Electron Microscopy (FESEM) and Atomic Force Microscopy (AFM). Fourier transform infrared spectroscopy-Attenuated total reflection (FTIR-ATR) spectroscopy was also used to investigate the functional groups of the PAN and M-PAN support surfaces. The water-contact angle was measured using a Ramé-Hart contact angle goniometer (Succasunna, N.J.).

Permeation testing was also conducted. A dead-end system was used for pressurized pure water permeation and salt/dye/pharmaceutical component rejection measurements, and a cross-flow system was used for the purification of water containing a pharmaceutical component (iodixanol) over an extended period. The concentrations of organic components in the feed and permeate were measured using a total organic carbon (TOC) analyzer (Tekmar Phoenix 8000-Persulfate), and salt concentration was measured using a conductivity meter (Pour Grainger International, Lake Forest, Ill., USA).

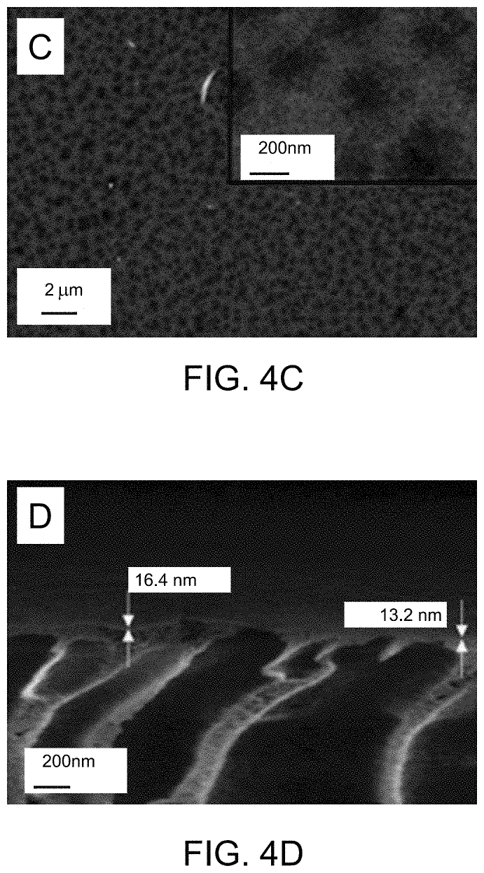

An easy, fast, and scalable GO printing method using a conventional inkjet printer was used to deposit ultrathin, high-quality GO nanofiltration membranes on a polymeric support. A commercial HP ink cartridge (resolution: 1,200 dots per inch, DPI) was used to hold the GO ink dispersion for printing as shown in FIG. 4(a). Field emission scanning electron microscopy (FESEM) showed that the orifice size of the inkjet cartridge hole (i.e., orifice or nozzle) was approximately 30 μm with a distance between holes in the same row of 90 μm and a distance between rows of 1,000 μm (see FIG. 2). To develop an effective GO ink for printing, two key properties of the GO dispersion were identified: GO flake size and GO concentration. It was found that dispersions with large GO flakes can block cartridge nozzles during printing, even at GO concentrations as low as 0.5 mg/mL. In contrast, dispersions with small GO flakes (˜500 nm) at the same concentration allowed for smooth printing without blockages. With GO concentrations higher than 4.0 mg/mL, ink blockage was observed even using the smaller GO flakes. At GO concentrations below 0.5 mg/mL, GO ink leakage was seen from the cartridge nozzles, apparently due to the lower viscosity of the GO dispersion. Thus, small GO flakes with concentrations ranging from 0.5 to 4 mg/mL were used in fabricating the printed GO membranes.

Polyacrylonitrile (PAN) ultrafiltration (UF) membranes with skin-layer pore sizes of 20-50 nm were selected as the base support for the GO printing. To improve hydrophilicity, the PAN support was hydrolyzed with sodium hydroxide solution. After this surface modification, no obvious surface or pore-size changes could be seen, but the surface became more hydrophilic and the water-contact angle decreased to 35°. Moreover, Fourier-transform infrared spectroscopy-attenuated total reflection (FTIR-ATR) spectra showed that the acrylonitrile (—CN) groups of the PAN support were converted to acid (—COOH) groups and amide (—CONH) groups during the hydrolysis process, which likely accounted for the improved hydrophilicity.

A printed GO coating was applied on the modified PAN (M-PAN) and appeared uniform by visual examination, and FESEM images showed a consistent uniform and thin GO coating. FIG. 4(b) shows an image of a large area (15×15 cm²) printed GO coating on an M-PAN support. FIG. 4(c), an FESEM image, shows a uniform GO coating surface on the M-PAN support, printed using 1 mg/mL GO ink. An FESEM cross-sectional view of the printed GO coating (FIG. 4(d)) shows only slight coating thickness variation, suggesting high uniformity of the printed GO layer. FIG. 4(f) shows water contact angle as a function of average printed GO thickness with “S” representing single-pass printing, “D” representing double-pass printing, and “Q” representing quadruple-pass printing.

To investigate how well the printing method could control the average thickness of the GO layer, FESEM images of GO coatings were taken using different concentrations of GO ink with single-pass printing. FIG. 4(e) shows the average GO coating thickness as a function of GO ink concentration after single-pass printing. As expected, printed GO coating thickness increased linearly with the increase in GO concentration, indicating an easy way of controlling GO coating thickness. To further verify the average GO coating thickness and coating uniformity, atomic force microscopy (AFM) was used to measure the thickness of the printed GO using different GO concentrations, and the results were consistent with the FESEM images.

Water wettability of the membrane surface is important for water permeation performance. FIG. 4(f) shows the water-contact angle of GO coatings printed under different conditions. In FIG. 4(f), “S” represents data obtained from single-pass printing, “D” represents data obtained from double-pass printing, and “Q” represents data obtained from quadruple-pass printing. For single-pass printing, water-contact angles were almost constant at 36-37° for 7.5 and 15 nm coatings, then increased to 47° and 49° for 30 nm and 60 nm coatings, respectively. For a fixed GO coating thickness, multiple printing passes were shown to decrease the water contact angle. At a fixed GO coating thickness of 30 nm, the water-contact angle decreased slightly, to 43° and 41° after double-pass and quadruple-pass printing, respectively.

AFM measurements of the GO coatings after single-pass printing showed that the surface roughness decreased gradually, from 33.7 to 22.4 nm with an increase in GO coating thickness from 7.5 to 30 nm, then increased to 31.4 nm for the 60 nm-thick GO coating. Because of the rough M-PAN support, a very thin GO coating (7.5 nm) conformably covered the support surface and replicated its high surface roughness. With an increase in GO coating thickness to 30 nm, the GO coating smoothed out the surface of the support. However, when the GO coating thickness was increased to 60 nm, the GO coating surface roughness increased.

For a fixed GO coating thickness, multi-pass printing appeared to have a negligible effect on surface roughness. FESEM images showed that for single-pass printing, a thin GO coating (˜15 nm) showed a conformal coating, replicating the support morphology, whereas thicker GO coatings (˜30 and ˜60 nm) had characteristics more closely resembling that of a GO coating on a completely smooth surface. For multi-pass printing of 30 nm coatings, slight surface morphology differences were seen. It is known that surface roughness influences water wettability and researchers have suggested that water wettability improves with an increase in nano-scale surface roughness. Thus, adapting the methods of present disclosure to have increased surface roughness may produce better membrane filtration performance.

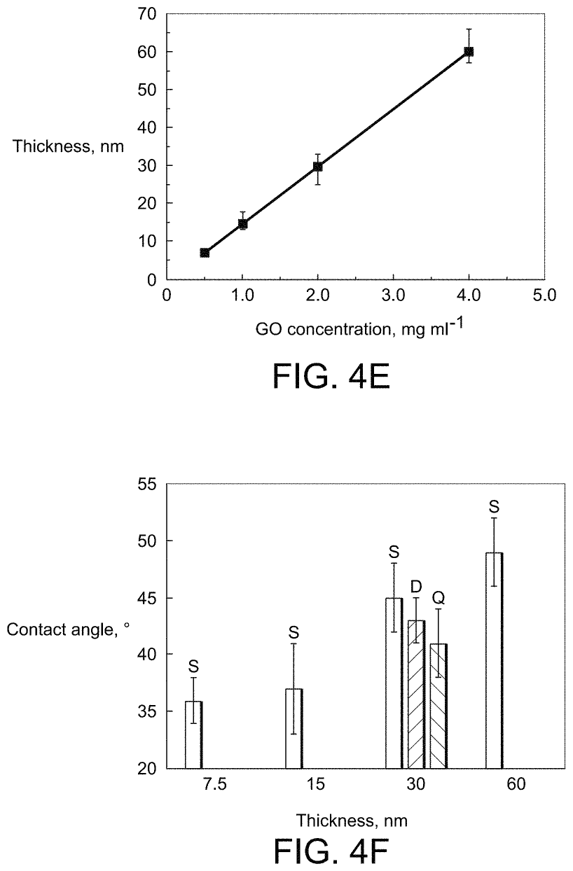

GO membranes printed under different conditions were evaluated for pure water permeation, rejection for dyes and pharmaceutical components, and brackish water desalination. FIGS. 5(a) and 5(b) show water permeation performance of printed GO membranes and comparisons with commercial polymeric nanofiltration membranes. FIG. 5(a) shows pure water permeance (PWP) of printed GO membranes as a function of thickness and printing times. Columns marked “S” show single-pass printing, columns marked “D” show double-pass printing, and columns marked “Q” show quadruple-pass printing. The numbers above each column are rejection rates of methyl orange (MO) at a pressure drop of 206.8 kPa. FIG. 5(b) shows the pure water flux of printed GO membranes (▪: 30 nm, double-pass printing) and commercial nanofiltration membranes (Δ: Microdyn Nadir; ⋄: Trisep®; ∘: Dow® Filmtec™). The MO rejection rates for each of membranes Microdyn Nadir, Trisep®, and Dow® Filmtec™ were 15.8%, 37.7%, and 75.6%, respectively.

FIG. 5A shows the pure water permeance (PWP) of GO membranes with different thicknesses and different printing times measured using a dead-end system. For single-pass printing (S), PWP increased slightly with an increase in coating thickness from 7.5 to 15 nm (although coating thickness doubled), then decreased markedly for 30 and 60 nm coatings (by 3.6 and 6.9 times, respectively). It is believed the lamellar nanostructure of GO membranes plays an important role in water permeation. For GO membranes with the same thickness, self-assembly of GO flakes using a longer relaxation time (i.e., a longer settling time) consistently resulted in 2.5-4 times higher PWP and higher salt rejection. This increase in PWP is believed to result from more and narrower hydrophobic domains that allow for faster and more selective water permeation.

Relative to the 7.5 nm coating, the 15 nm GO coating was expected to have a longer drying time. Further, a better self-assembled interlayer nanostructure may form allowing for greater water permeation. The PWP of a 15 nm GO membrane, therefore, is actually higher than that of a 7.5 nm membrane, although it is twice as thick. For still thicker GO coatings (30 and 60 nm), although a better self-assembled interlayer nanostructure with a faster water permeation rate may result, the much thicker GO coating (and thus higher transport resistance) resulted in the greatly reduced PWP. For multi-pass printed 30 nm GO coatings, with an increase in printing time, PWP increases gradually. This increase in PWP is probably due to improved self-assembly during the multiple rounds of the printing and drying process. Thus, the PWP of printed GO membranes can be controlled by coating thickness, printing passes, and printing time. Additionally, optimized coating thickness and multi-pass printing may greatly enhance PWP.

Both water permeance and rejection of small organic molecules are vital in evaluating nanofiltration membranes. Methyl orange (MO; molecular diameter: 0.79 nm; charge: −1) was selected as a probe molecule to examine the ability of the printed GO membranes to filter. The filtration rates of MO are represented by the numbers above the columns in FIG. 5(a). Before each dye-rejection measurement, pure-water permeation was conducted until a steady state permeance was obtained and then dye filtration was performed. Dye rejection after two-hour filtration was then reported. Typically, water permeance decreased slightly, by ˜15%, after two hours of MO filtration testing. The thinnest 7.5 nm GO coating had the lowest rejection (79.6%), likely due to its thickness and uncovered substrate support pores.

Increased GO coating thickness increased MO rejection gradually and the 60 nm GO coating showed the highest rejection (96.7%). For 30 nm GO coatings, double-pass printing resulted in comparable rejection measurements to that of a 60 nm coating, but the PWP was 3.5 times higher. For 30 nm GO coatings, multi-pass printing (double-pass and quadruple-pass) generally led to improved filtration of MO, probably resulting from the narrower hydrophobic channels due to better self-assembly during the drying (between printing) and rewetting (during printing) process. The MO rejection results indicated that the printed GO membranes had rejection performance in the nanofiltration range, and that coating thickness and printing time are important for controlling filtration performance.

To compare the nanofiltration performance of printed GO membranes with commercial nanofiltration membranes, 30 nm GO membranes with double-pass printing was used because of its excellent MO rejection and moderate PWP. Thirty nanometer GO membranes with double-pass printing were also used to test the printed GO membranes with charged and uncharged dyes with different molecular diameters to further evaluate nanofiltration performance (See Table 1, below). High rejection rates were obtained supporting that printed GO membranes make excellent nanofiltration membranes. Three commercial nanofiltration membranes (from Microdyn Nadir, Trisep®, and Dow® Filmtec™) were selected for water flux comparisons. FIG. 5(b) shows water flux versus pressure drop for the double-pass printed, 30 nm GO membrane and the commercial nanofiltration membranes. (▪: 30 nm, double-pass printed; Δ: Microdyn Nadir; ⋄: Trisep®; ∘: Dow® Filmtec™).

The water flux of the printed GO membrane was about 10 times higher than that of the commercial nanofiltration membranes, whereas the commercial membranes had much lower MO rejection (FIG. 5(b)). These results indicated that the printed GO membranes have great potential for high permeance and high-rejection nanofiltration applications. The PWP and MO rejection of the printed GO membranes were comparable to, or higher than, membranes of the prior art. And, membrane fabrication processes of the prior art are more difficult to scale-up.

TABLE 1
Dye rejection of two-time printed, 30-nm GO membrane.

| | Molecular | | | |
|---|---|---|---|---|
| | diameter, | Molecular | | |
| Dye molecule | nm^{[9]} | weight, g/mol | Charge | Rejection, % |
| Methyl orange | 0.79 | 327.3 | −1 | 95.9 |
| Riboflavin | 0.83 | 376.3 | 0 | 97.6 |
| Basic blue | 0.86 | 359.89 | 1 | 96.3 |
| Acid blue 45 | 0.84 | 474.33 | −2 | 99.9 |
| Acid blue 80 | 1.02 | 678.68 | −2 | >99.9% |

Another potential use of nanofiltration membranes is to remove contaminants of emerging concern (CECs) from water, including pharmaceuticals and personal care products, antibiotics, endocrine-disrupting compounds, and their human-produced metabolites. The filtration performance of four different pharmaceutical contaminants was measured using a double-pass printed 30 nm GO membrane after 2 hours of permeation in a dead-end system. The GO membrane showed excellent filtration percentages of 76.4%, 80.1%, 83.0%, and 95.2% for gemfibrozil, 17α-ethynylestradiol, diclofenac sodium salt, and iodixanol, respectively. For reference, most commercial polymeric nanofiltration membranes generally have rejection percentages of <50% for these organic compounds.

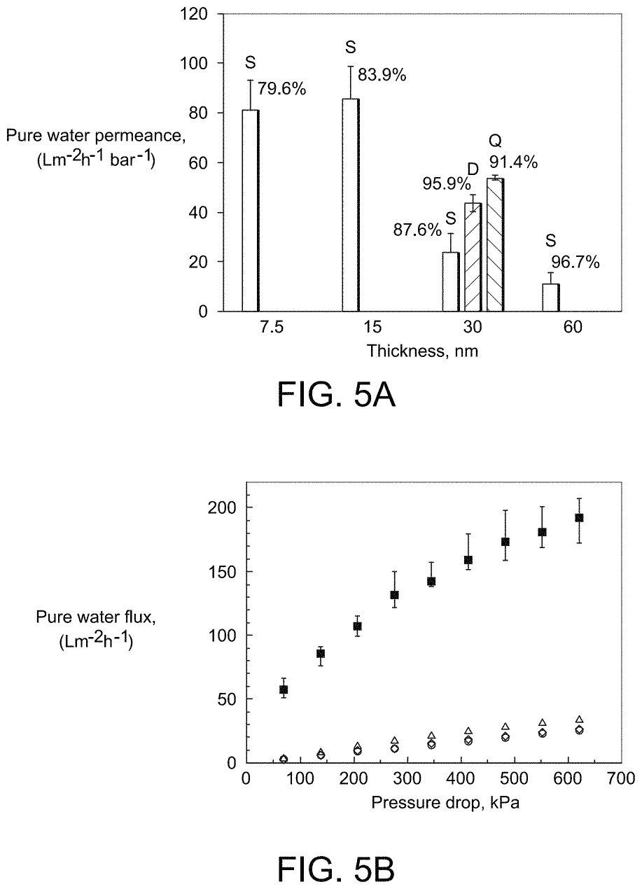

FIG. 6 shows the nanofiltration performance of printed GO membranes (a double-pass printed, 30 nm GO membrane) removing iodixanol (10 ppm) using a cross-flow system over an extended operating period (J₀=DI water permeability, J=iodixanol/water permeability; ▪: 30 nm, double-pass printed membrane, A: Microdyn Nadir). In 120 hours of runtime, water permeance decreased by <10%, with a slight decrease in rejection rate from >99% to 94% at 20 hours, and was constant thereafter. The feed concentration of iodixanol was also measured after collecting 100 mL of filtrate from 300 mL of feed. It was found that the ratio of the feed side final concentration to initial concentration was 1.29, suggesting that exclusion, not membrane adsorption, was the dominant mechanism for the achieving high filtration rates (i.e., the percentage of contaminants removed). These results demonstrate that printed GO membranes have excellent stability and negligible fouling during nanofiltration.

In conclusion, it was demonstrated that printing using a conventional inkjet printer is a low-cost, easy, fast, and scalable method for depositing ultrathin GO membranes with high water permeance and high-rejection nanofiltration. Water permeance and rejection of small organic molecules of printed GO membranes can be tuned by adjusting the GO coating thickness and printing passes. Compared with commercial nanofiltration membranes, the printed GO membranes showed approximately one order of magnitude higher water permeance and higher rejection of small organic molecules. The printed GO membranes also showed excellent nanofiltration performance when removing pharmaceutical contaminants in water, as well as excellent long-term stability. Further, this method can be scaled up to mass-manufacture industrial membranes for high volume desalination and other applications.

### Example 2

Large, single-layered GO flakes were synthesized and characterized thoroughly to determine surface functional groups, elemental composition, area, and thickness. Expandable graphite was first heated for 30 seconds in a microwave oven to obtain expanded graphite. Graphene oxide (GO) was synthesized from the expanded graphite using a modified Hummers method. Five-hundred mL of concentrated H₂SO₄ was charged into a 3 L flask equipped with a mechanical stirrer. An ice bath was used to decrease flask temperature to around 0° C. Five grams of expanded graphite were slowly added into a flask while stirring. Then, 30 g of KMnO₄ was gradually added to the expanded graphite suspension and mixed for 2 hours at 35° C. The flask was then chilled again in the ice bath, and 1 L of deionized water was slowly added to maintain a temperature below 70° C. Fifty ml of H₂O₂ (30 wt %) was added to the suspension, and the color of the suspension changed from dark brown to yellow. The oxidized product was purified by rinsing with a 5% HCl solution and repeatedly washing with DI water.

A commercial inkjet printer was used to prepare printed GO layers using GO ink. A close-up picture of the printer head can be seen in FIG. 2. The volume of each GO ink drop expelled from the printer head was about 22×10⁻¹² L. Moreover, each drop covered an average surface area of approximately 90×1,000 μm² on the go membrane. Therefore, the volume of GO ink applied relative to the surface area of the membrane was about 0.00244 ml cm⁻². For GO ink with a concentration of 1 mg ml⁻¹, GO loading per area was about 0.00244 mg cm⁻². Assuming a GO density of 1.8 g cm⁻³, the GO coating thickness on the substrate was approximated to be 13.6 nm for each printing pass. The GO coating thicknesses was calculated similarly for different concentrations of GO ink and different numbers of printing passes.

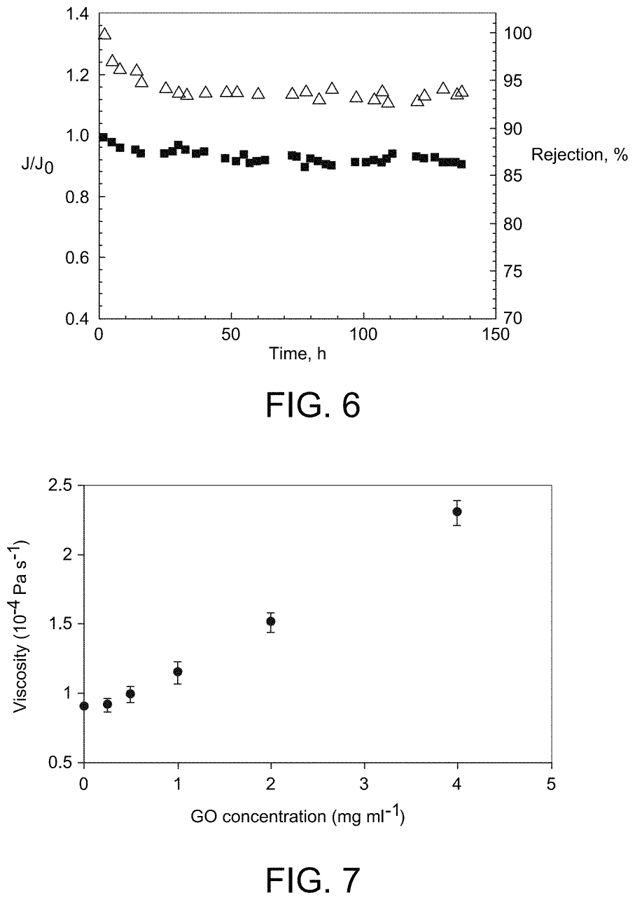

FIG. 7 is a graph of GO ink viscosity as a function of GO concentration. The viscosity of GO ink was measured at ambient temperature using glass capillary viscometers (50 L199, Canon Instrument Company). The glass capillary viscometers were filled with GO ink using suction to pull GO ink to the upper volume mark within the viscometer. The liquid flow time down to the lower calibrated mark of the glass viscometer was measured. The provided calibration constant from the manufacturer was used to calculate the viscosity of the GO ink solutions. The viscosity of the GO ink solutions as a function of GO concentration is shown in FIG. 7.

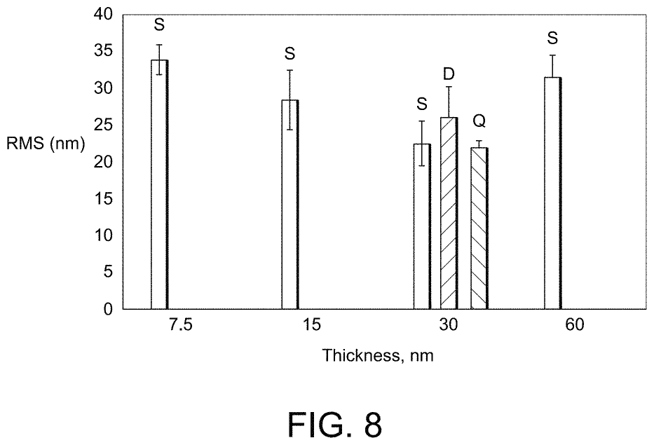

FIG. 8 is a graph of root mean square (rms) surface roughness (in nanometers) for various thicknesses of GO layers (“S” represents single-pass printing; “D” represents double-pass printing; and “Q” represents quadruple-pass printing). FIG. 8 shows that surface roughness decreased as the GO layer increased in thickness to 30 nm and then increased when the GO layer was above 30 nm in thickness. For the 30 nm thick go layers, the surface roughness was relatively the same for single-pass printing (S), double-pass printing (D), and quadruple-pass printing (Q).

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A printing method of applying graphene oxide (GO) to a substrate comprising:
producing GO ink by mixing GO particles with a solvent; and
printing the GO ink on the substrate by expelling droplets of GO ink on the substrate.

2. The method of claim 1, wherein the solvent includes water.

3. The method of claim 1, wherein the solvent includes ethanol or acetone.

4. The method of claim 1, wherein the solvent includes from about 30 wt. % to about 50 wt. % ethanol and water.

5. The method of claim 1, wherein the mixing the GO particles with the solvent includes sonication.

6. The method of claim 1, wherein the producing GO ink comprises passing the GO ink through a filter to remove GO agglomerates.

7. The method of claim 1, wherein the GO ink comprises GO flakes with an average diameter of less than 500 nm.

8. The method of claim 1, wherein the GO ink has a GO concentration of from about 0.5 mg/mL to about 4.0 mg/mL.

9. The method of claim 1, wherein the GO ink is expelled through one or more orifices having a diameter of from about 5 μm to about 50 μm.

10. The method of claim 1, wherein the droplets have a diameter of from about 10 μm to about 100 μm.

11. The method of claim 1, wherein the GO ink is expelled by a piezoelectric driving force.

12. The method of claim 1, wherein the GO ink is expelled by a thermal driving force.

13. The method of claim 1, wherein the GO ink is applied at from about 100 dpi to about 2000 dpi.

14. The method of claim 1, wherein the substrate is a porous substrate.

15. The method of claim 1, wherein the substrate is a polyacrylonitrile (PAN) film, a polymer fabric, or a poly-sulfone film.

16. The method of claim 1, further comprising treating the substrate with a base such as sodium hydroxide prior to the expelling of the droplets of the GO ink on the substrate.

17. The method of claim 1, wherein multiple printing-passes are used to apply the graphene oxide ink to the substrate.

18. The method of claim 1, wherein the GO ink is applied to the substrate until a dried layer of from about 7.5 nm to about 30 nm remains on the substrate.

19. The method of claim 1, wherein GO flakes on the substrate form nanochannels having a width of from about 0.7 nm to about 1.1 nm.

20. A graphene oxide (GO) membrane comprising:
a porous substrate comprising a polymer film polyacrylonitrile (PAN), a polymer fabric, or a poly-sulfone film; and
a printed-layer of graphene oxide that has a thickness ranging from about 7.5 nm to about 60 nm.
